(19) United States
(12) Patent Application Publication
(10) Pub. No.: US 2011/0266021 A1
(43) Pub. Date: Nov. 3, 2011

(54) Floor Plug Electrical Box

(76) Inventors: Roy Bouse, Port Bolivar, TX (US); Lucas Bouse, Port Bolivar, TX (US)

(21) Appl. No.: 13/097,018

(22) Filed: Apr. 28, 2011

Related U.S. Application Data
(60) Provisional application No. 61/328,662, filed on Apr. 28, 2010.

(51) Int. Cl. H01H 13/04

(52) U.S. Cl. 174/55

(57) ABSTRACT

An electrical receptacle box device that is installed by the practitioner in a desired floor location to allow proximal electrical access for corded electrical devices. The device includes lid and door aspects to disguise and cover the box when installed flush with the floor. The device further includes a void space for excess cord storage, thus improving safety, and a means of mounting the receptacles within the box either vertically or horizontally per the preference of the practitioner. The lid of the device also includes apertures and cut-outs to allow cords to pass through the door when shut, disguising the unsightly appearance of a traditional electrical receptacle.

### CROSS REFERENCE TO RELATED APPLICATION

This application claims the benefit of U.S. Provisional Application No. 61/328,662 filed on Apr. 28, 2010, entitled “Bouse Floor Plug.”

### BACKGROUND OF THE INVENTION

1. Field of the Invention

The present invention relates to an inset electrical box device designed to sit flush with the surrounding surface, thereby providing an effective means of electrical outlet access without creating safety hazards or interfering with nearby décor.

Basic electrical boxes are insulating receptacles for retaining electrical power devices within walls, floors and ceilings of buildings in order to provide a safe electrical housing. Most common electrical boxes are made to standard sizes and shapes, formed as single or multiple-gang boxes for respectively housing one or more electrical devices. Electrical boxes may be covered with a plate, which further encloses and insulates the electrical device, while also providing a finished decorative appearance. Such plates are made in a variety of standard sizes to suit a variety of purposes. For example, a floor box plate may have a tapered edge if used on a carpeted floor. Another type may have a flat edge for receiving an abutting edge of tile if used on a tile floor. Such standard components can create problems for consumers and field personnel, who may not find the standard components suited to their particular needs.

Installation of currently available floor electric receptacle boxes is typically at or slightly above floor level. Cords plugged into these outlets must lay sprawled out on the floor or frequently jut upwards from the receptacle box, as there is no means of containment. Additionally, such receptacle boxes often have lids, which flip up or are removed to accommodate cords. Unfortunately, improperly or hastily inserted cords may result in receptacle box lid displacement in an unsightly or hazardous manner. For example, access doors may be open or ajar due to cabling and wiring passing through an in-floor fitting. Passersby can easily trip over the cords or receptacle box lids and sustain injury. On an aesthetic level, these traditional receptacle boxes are unappealing and unsightly, and not suited for placement in visible areas. Furthermore, many consumers do not like the look of cords and plugs exposed in the middle of meticulously decorated spaces. An effective solution for the everyday consumer is necessary.

The present invention is flush mount electrical receptacle box designed to provide electrical outlets where needed, without the creation of safety hazards or interference with the surrounding decor. The present invention allows for the placement of electrical outlets below the surface of the floor with a receptacle box mounted flush with the planar surface of the floor. Use of the present invention allows items such as lamps, stereos, televisions, and other electrical items to operate in any location without unsightly outlets or hazardous cords. Installation of the present invention may be in any space where electronics are required, allowing easy concealment with decorative rugs, paneling or furniture, even in the middle of open spaces. Further, the present invention secures electrical cords in place and retains them under the floor where consumers cannot trip over them accidentally. The present invention is ideal for use in homes, businesses, offices, and other similar venues.

2. Description of the Prior Art

Patents have been granted to several devices that attempt to address the issue of concealment and safety of electrical receptacles. However, the prior art fails to provide a device usable in both home and business environments that takes into account the foregoing issues. Further, the prior art is targeted towards business and commercial office installation, and does not take into account the needs of the home user.

Forsyth U.S. Pat. No. 3,636,495 is directed to an electrical plug for three-phase, high-power electrical applications. The plug is adapted for use in connection with a floor receptacle and has a generally flat, thin casing to provide a low profile on the floor. Safety means are provided within the casing to prevent electrical flashover between the terminals and to prevent the ingress of moisture into the casing. A socket is provided on the casing to act as additional support for the terminal elements and to provide an enclosure therefor. The invention disclosed in Forsyth describes a high power electrical plug for high voltage appliances. As such the Forsyth invention is both unsuitable and undesirable for standard home and office applications.

Other examples of prior art are directed to office and commercial applications. In particular they are intended to be hooked to both electrical and communications lines, as well as installed within a concrete slab with metal conduit. Bowman U.S. Pat. No. 5,467,565 is directed to a method and apparatus for activation of services in a concrete floor of an office building from below floor slab distribution systems. Void-forming boxes that are secured to a conventional metal deck sheet and surrounded by the concrete floor slab provide chambers in which in-floor electrical fixtures are mounted. Connection hardware is secured to the metal deck sheet for connection to a conventional below-floor slab service distribution system providing communication from the interior of the box to the below-floor slab service distribution system. Similarly, Young U.S. Pat. No. 5,796,037 is directed to an electrical floor box providing connections to one or more in-floor service distribution systems. The Young invention includes lower and upper portions defining a hollow interior and a plurality of wiring compartments and conduction tunnels interconnecting the wiring compartments.

In a similar manner, Bowman U.S. Pat. No. 7,183,503 is directed to an in-floor fitting for providing access to an underfloor electric distribution system. The in-floor fitting includes a cover configured to move between open and closed positions and being moved to an open position to allow a cable to pass therethrough. The in-floor fitting includes a receptacle positioned below the cover and configured to operatively connect to a cable comprising at least one of an electrical cable and a communication cable, wherein the cover is substantially flush with a surface of a floor when the cable is operatively connected to the receptacle and the cover is in the closed position.

The prior art mentioned in the foregoing descriptions are directed toward office based applications of electrical boxes. As such, applications of these utilitarian inventions will not be desirable in a home or office in which both aesthetics and functionality are a concern. It is unlikely that home use will necessitate or even allow the installation of such commercial boxes. Rather, homeowners will desire electrical boxes such as the present invention, which may interface with standard home electrical systems and be aesthetically appropriate with decor.

Markiewicz U.S. Pat. No. 5,866,845 is directed to an electrical box in which an enclosure is provided that includes a base, sides and at least one yoke for receiving an electrical device. The box enclosure can be formed of discrete components, which can be assembled to form a single or multiple-gang box. The Markiewicz invention is an adaptation of a traditional electrical receptacle or switch box, intended to allow the practitioner to use multiple attached boxes in a side-by-side manner. Further, Markiewicz is designed to address the issue of fluid access to the electrical device. The invention described in Markiewicz fails to address the issues of floor mounted electrical box installation, concealment and safety.

Other prior art is directed toward concealing receptacles when not in use. Riedy U.S. Pat. No. 6,265,662 is directed to an apparatus for use with an electrical receptacle and a floor box. A first part of the apparatus defines a floor plate, which is configured to fit over the floor box in an installed position. The floor plate has an inner edge surface defining an access opening for providing access to the receptacle. A second part of the apparatus defines an access door for closing the access opening. The invention described in Riedy functions to obscure and protect electrical or communications outlets when not in use. During use, the door on the surface of the receptacle box must remain open, resulting in an unsightly and potentially dangerous issue, thereby limiting the receptacle to temporary usage. The present invention addresses the issue by allowing the receptacle box lid to remain closed at all times and providing a small opening from which the cords may extend outward.

These prior art devices have several known drawbacks, however the most significant of these is the intention of commercial use. Such commercial devices typically require embedding in cement or integration with a metal conduit framework. Cement and metal conduit are rarely used outside of commercial applications, thus making use or much of the prior art in a home setting prohibitive. Additionally, the prior art fails to address the issue of electrical box lids left ajar or open when in use, leading to situations that are both unsafe as well as unsightly. The prior art fails to account for the sprawling and unsafe usage of electrical cords, whereas the present invention provides a means for their storage in a safe manner. Further, unlike the prior art, the present invention allows for the lid and door of the electrical box to be covered with flooring to match the surrounding area. Thus, while the prior art is aimed at office and commercial usage, the present invention provides distinct advantages for home usage.

The present invention will greatly assist users with electrical appliance and device management by allowing the placement of electrical receptacles in any location in a safe and aesthetically pleasing manner.

### SUMMARY OF THE INVENTION

In view of the foregoing disadvantages inherent in the known types of electrical receptacle enclosures now present in the prior art, the present invention provides a new receptacle box wherein the same can be utilized for providing a convenient device for the user for the safe, aesthetically pleasing and efficient placement of electrical outlets.

The present invention is a device designed to provide electrical outlets where needed, without creating safety hazards or interfering with the surrounding decor. The device allows installation of electrical outlets below the surface of the floor, allowing items such as lamps, stereos, televisions, and other electrical items to operate in any desired location. The present invention is to be installed in any space where electronics are required, and can be easily concealed by decorative rugs or furniture. The present invention holds electrical cords securely in place and stored under the floor where consumers cannot trip over them accidentally. The present invention is ideal for use in homes, businesses, offices, and other similar venues.

It is therefore an object of the present invention to provide a recessed electrical receptacle box that may be mounted flush with the surrounding floor wherever the practitioner has need. Another object of the present invention is to provide a device to contain excess cord lengths for safety. Yet another object of the present invention is to provide a removable, operable lid made of material suitable for concealment of the electrical receptacle box.

Other objects, features and advantages of the present invention will become apparent from the following detailed description taken in conjunction with the accompanying drawings.

### BRIEF DESCRIPTIONS OF THE DRAWINGS

FIG. 1 is a perspective view of the present invention with the removable lid in place.

FIG. 2 is a perspective view of the receptacle box portion of the present invention in both one and two receptacle formats.

FIG. 3 is a perspective view of another embodiment of the receptacle portion of the present invention, in which the outlets are mounted vertically.

### DETAILED DESCRIPTION OF THE INVENTION

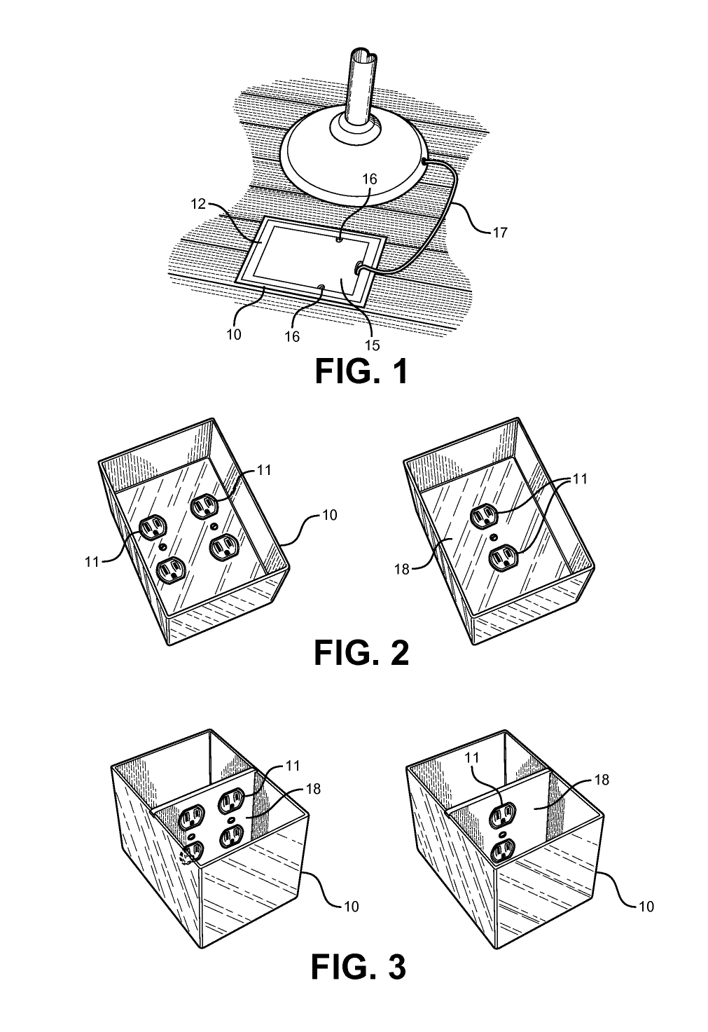

Referring now to FIG. 1, there is shown a perspective view of the present invention mounted flush with a floor or other surface. The present invention consists of a box structure 10 into which a receptacle 11 and removable lid 12 may be installed. The box structure 10 is mounted slightly recessed within a floor or other surface. Once mounted, a removable lid 12 with an operable door 15 is attached to the box structure 10 and aligned flush with the floor or other surface. The removable lid 12 is equipped with one or a plurality of apertures or semi-circle cut-outs 16 through which cords 17 plugged into the receptacle 11 may be passed. The lid 12 may allow for the attachment of wood, carpet or any other flooring material that is aesthetically pleasing to the practitioner. The removable lid 12 may be completely removable from the box structure 10, or alternatively hinged along one side or snapped into place.

Referring now to FIG. 2, there is shown a perspective view of the box structure 10 portion of the present invention in which the electrical receptacles 11 are mounted horizontally. The box structure recesses the receptacles 11 several inches below the top of the box, allows for coiling and storage of excess lengths of cord 17 in the void space 18. The lid 12 and operable door 15 may be attached to the top of the box structure allowing concealment.

Referring now to FIG. 3, there is shown an alternative embodiment of the box structure 10 of the present invention, in which the receptacles 11 are mounted vertically. The box structure 10 provides sufficient void space 18 for the coiling and storage of excess lengths of cord 17. The lid 12 and operable door 15 may be attached to the top of the box structure allowing concealment.

In use the present invention provides practitioners with a sub-floor electrical outlet that conveniently hides cords for added safety. The present invention may be comprised of a rectangular box structure 10 that measures approximately 5″ in height, 7″ in length, and 5″ in width. The box structure 10 may contain single or double electrical receptacles 11 and can be made of suitable plastic or metal material. The electrical receptacles 11 may be installed horizontally inside the box structure 10 as shown in FIG. 2. Alternatively, the electrical receptacles may be installed vertically inside the box structure 10, as shown in FIG. 3, and may face the front or the back of the box. A lid 12 with an operable door 15 made of brass or other metal material may be included to allow users access to the electrical receptacles 11. Alternatively, the lid 12 and door 15 may be made of, or allow the attachment of, other flooring materials suitable to the needs of the practitioner. When closed, this lid 12 and door 15 provide a sleek, finished look while concealing the receptacles 11. Electrical cords 17 may be held securely in place by semi-circle cut-outs 16 on the lid.

The box structure can be recessed into the floor at any desired location, allowing the lid 12 and door 15 to sit flush with the surrounding surface. Installation may be achieved using one or more brackets or other attachment fixtures, designed to attach the box structure 10 at floor level. Additionally, the box structure 10, contains one or a plurality of punch out apertures to allow access to the home or office wire system.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. An electrical floor box comprising:
a box structure defining a rectangular hollow interior;
one or more of said box structure walls having one or a plurality of knockout apertures for electrical system line access;
means of mounting said box structure at floor level;
said hollow interior being sufficient to accommodate coiled electronic device cords;
means to mount and secure an electrical receptacle or switch within said hollow interior;
a lid component with an openable door attached to said box structure;
and said door containing one or a plurality of apertures or semi-circular cut-outs for electrical device cords.

2. The electrical box of claim 1, wherein said lid and door have a finished surface.

3. The electrical box of claim 1, wherein said lid and door have a recessed surface for receiving carpet, tile or other surface material.

4. The electrical box of claim 1, further comprising means to mount one or more electrical receptacles horizontally within the electrical box.

5. The electrical box of claim 1, further comprising means to mount one or more electrical receptacles vertically within the electrical box.

6. The electrical box of claim 1, said openable door is removably attached to said box structure.

7. The electrical box of claim 1, said openable door is hinged along one of its sides to said box structure.

8. The electrical box of claim 1, said openable door is secured to said box structure by snap means.
